(19) United States
(12) Patent Application Publication
(10) Pub. No.: US 2025/0115149 A1
(43) Pub. Date: Apr. 10, 2025

(54) CONTROL DEVICE

(71) Applicant: Toyota Jidosha Kabushiki Kaisha, Toyota-shi (JP)

(72) Inventor: Yuya YAMAUCHI, Nagoya-shi (JP)

(73) Assignee: Toyota Jidosha Kabushiki Kaisha, Toyota-shi (JP)

(21) Appl. No.: 18/755,974

(22) Filed: Jun. 27, 2024

(30) Foreign Application Priority Data
Oct. 10, 2023 (JP) 2023-175236

(51) Int. Cl. B60L 53/62; B60L 53/16

(52) U.S. Cl. CPC B60L 53/62; B60L 53/16

(57) ABSTRACT

The server (control device) includes a communication device (acquisition unit) that acquires information about the amount of electric power required to move from EVSE (charger) to each basic point of the plurality of electrified vehicle. The server includes a processor for controlling the charge of each of the plurality of electrified vehicle by EVSE. The processor performs charging control (first charging control) so that the storage amount of each of the plurality of electrified vehicle reaches the necessary power amount, and then performs charging control (second charging control) for charging each of the plurality of electrified vehicle.

### CROSS-REFERENCE TO RELATED APPLICATION

This application claims priority to Japanese Patent Application No. 2023-175236 filed on Oct. 10, 2023, incorporated herein by reference in its entirety.

### BACKGROUND

### 1. Technical Field

The present disclosure relates to a control device.

### 2. Description of Related Art

Japanese Unexamined Patent Application Publication No. 2018-191471 (JP 2018-191471 A) discloses a charging control method in which batteries of a plurality of battery electric vehicles are sequentially charged by a charger.

### SUMMARY

Although not explicitly described in JP 2018-191471 A, when multiple battery electric vehicles are sequentially charged, a charge amount of a battery electric vehicle to be charged later may be limited until a storage amount of a battery electric vehicle to be charged first reaches a predetermined value (e.g., full charge). In this case, it is conceivable that the battery electric vehicles to be charged later will be insufficiently charged and unable to move to its own basic point (charging basic point). Also, it is conceivable that there will be a battery electric vehicle among the battery electric vehicles that desires a greater charge than a power amount required to move to its own basic point.

The present disclosure has been made in order to solve the above problems, and an object thereof is to provide a control device that is capable of securing at least a charge amount by which each of multiple electrified vehicles can move to its own basic point, and also further increasing a storage amount of the electrified vehicles.

A control device according to an aspect of the present disclosure is a control device for controlling charging of a plurality of electrified vehicles by a charger. The control device includes
an acquisition unit that acquires information regarding a necessary power amount that is required for moving from the charger to a basic point of each of the electrified vehicles, and a processor that controls charging of each of the electrified vehicles by the charger.
   The processor executes first charging control such that a storage amount of each of the electrified vehicles reaches a first target value that is based on the necessary power amount, and the processor executes, after the first charging control, second charging control to charge at least one of the electrified vehicles.

The control device according to an aspect of the present disclosure executes the first charging control such that the storage amount of each of the electrified vehicles reaches the first target value, based on the necessary power amount as described above. Further, the control device executes the second charging control of charging at least one of the electrified vehicles after the first charging control. Thus, by the first charging control, the storage amount of at least one electrified vehicle can be increased beyond the first target value, by the second charging control, while securing the charge amount such that the storage amount of each of the electrified vehicles reaches at least the first target value. Accordingly, the storage amount of the electrified vehicles can be further increased, while securing at least the charge amount by which each of the electrified vehicles can move to its own basic point.

In the control device according to the above aspect, preferably, when the electrified vehicles include a plurality of charging vehicles to be charged in the second charging control, the processor performs control to equalize charging power allocated from the charger to each of the charging vehicles in the second charging control. According to this configuration, multiple charging vehicles can be uniformly charged by the second charging control.

Here, an assumption will be made that the charger includes a charging connector that is connected to a charging port provided in each of the electrified vehicles. In the control device according to the above aspect, preferably, when the electrified vehicles include a plurality of charging vehicles to be charged in the second charging control, the processor preferentially charges, out of the charging vehicles, a charging vehicle of which timing of connecting the charging connector in the second charging control was early. According to this configuration, the storage amount of the charging vehicle regarding which the timing of connecting the charging connector was earlier can be preferentially increased by the second charging control.

Here, an assumption will be made that each of the electrified vehicles is set to be charged by the second charging control until the storage amount reaches a second target value that is greater than the first target value. In the control device according to the above aspect, preferably, when the electrified vehicles include a plurality of charging vehicles to be charged in the second charging control, the processor preferentially charges, out of the charging vehicles, a charging vehicle regarding which a difference between the storage amount after the first charging control and the second target value in the second charging control is great. According to this configuration, the storage amount of each of the charging vehicles can be easily brought to be close to the second target value.

In the control device according to the above aspect, preferably, when the electrified vehicles include a plurality of charging vehicles to be charged in the second charging control, the processor preferentially charges, out of the charging vehicles, a charging vehicle regarding which a scheduled departure time, for departing from the charger in the second charging control, is earlier. According to this configuration, a situation in which the charging of the charging vehicle of which the scheduled departure time is early is insufficient can be suppressed.

According to the present disclosure, the storage amount of multiple electrified vehicles can be further increased, while securing at least a charge amount by which each of the electrified vehicles can move to its own basic point.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to an embodiment;

FIG. 2 is a block diagram illustrating functional features of a processor according to one embodiment;

FIG. 3 is a sequence diagram illustrating control in a system according to one embodiment;

FIG. 4 is a sequence diagram illustrating control in the system according to the first modification of the embodiment;

FIG. 5 is a flow chart showing the control in the system according to the second modification of the embodiment; and

FIG. 6 is a sequence diagram illustrating control in a system according to a third modification of the embodiment.

### DETAILED DESCRIPTION OF EMBODIMENTS

Hereinafter, an embodiment of the present disclosure will be described in detail with reference to the drawings. The same or corresponding parts in the drawings are designated by the same reference characters and repetitive description will be omitted.

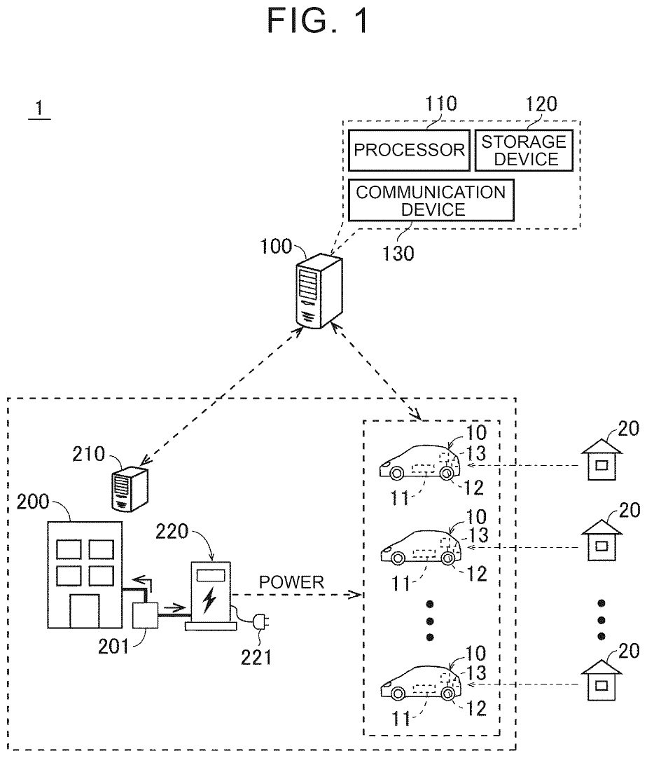

FIG. 1 is a diagram illustrating a configuration of a system 1 according to the present embodiment. The system 1 includes a server 100, a managing server 210, an Electric Vehicle Supply Equipment (EVSE) 220, and a plurality of electrified vehicle 10. The server 100 and EVSE 220 are exemplary “control device” and “charger” of the present disclosure, respectively.

Electrified vehicle 10 include, for example, Plug-in Hybrid Electric Vehicle (PHEV), Battery Electric Vehicle (BEV), or Fuel Cell Electric Vehicle (FCEV).

Electrified vehicle 10 includes a battery 11, a communication unit 12, and an inlet 13. Power for driving electrified vehicle 10 is stored in the battery 11. The communication unit 12 is configured to be able to communicate with a server 100 (a communication device 130 described later). Further, electrified vehicle 10 is configured to be electrically connectable to EVSE 220 by connecting a charging connector 221, which will be described later, to the inlet 13. In the following description, the connection of the charging connector 221 to electrified vehicle 10 (inlet 13) may be referred to as plug-connection. Note that the inlet 13 is an example of a “charging port” of the present disclosure.

EVSE 220 means a vehicular power supply facility. EVSE 220 is installed, for example, in a parking lot or the like of the accommodation facility 200. Although only one EVSE 220 is shown in FIG. 1 for simplicity, a plurality of EVSE 220 is actually installed. EVSE 220 comprises a charging connector 221. With the charging connector 221 connected to electrified vehicle 10 (inlet 13), charging from EVSE 220 to electrified vehicle 10 is performed.

Electrified vehicle 10 battery 11 is supplied with the electric power stored in the power storage device 201 of the accommodation facility 200 through EVSE 220. Note that the electric power of the power storage device 201 is also consumed when a household electric appliance or the like is used in the accommodation facility 200.

Power storage device 201 is supplied with power from a power system (not shown). The power storage device 201 may be supplied with electric power from a photovoltaic power generation system (not shown) installed in the accommodation facility 200. The power storage device 201 may be supplied with electric power from an electrified vehicle 10 through a EVSE 220.

The management server 210 manages the power state of the power storage device 201 of the accommodation facility 200. The managing servers 210 manage electric power (kW) consumed from the power storage device 201 by electrified vehicle 10 charge or the like. Here, the upper limit (kW) of the electric power per unit time that can be taken out from the power storage device 201 is determined in advance by the contract. The upper limit value may be referred to as contract power hereinafter. The management server 210 calculates the surplus power per unit time that can be extracted from the power storage device 201 from the relationship between the upper limit value (contract power) and the power consumption. The calculated information of the surplus power is transmitted from the management server 210 to the server 100 (a communication device 130 described later). Note that the above-described surplus power may be calculated by the server 100.

The server 100 controls the charge of a plurality of electrified vehicle 10 using EVSE 220. The server 100 includes a processor 110, a storage device 120, and a communication device 130. The communication device 130 is an example of an “acquisition unit” of the present disclosure.

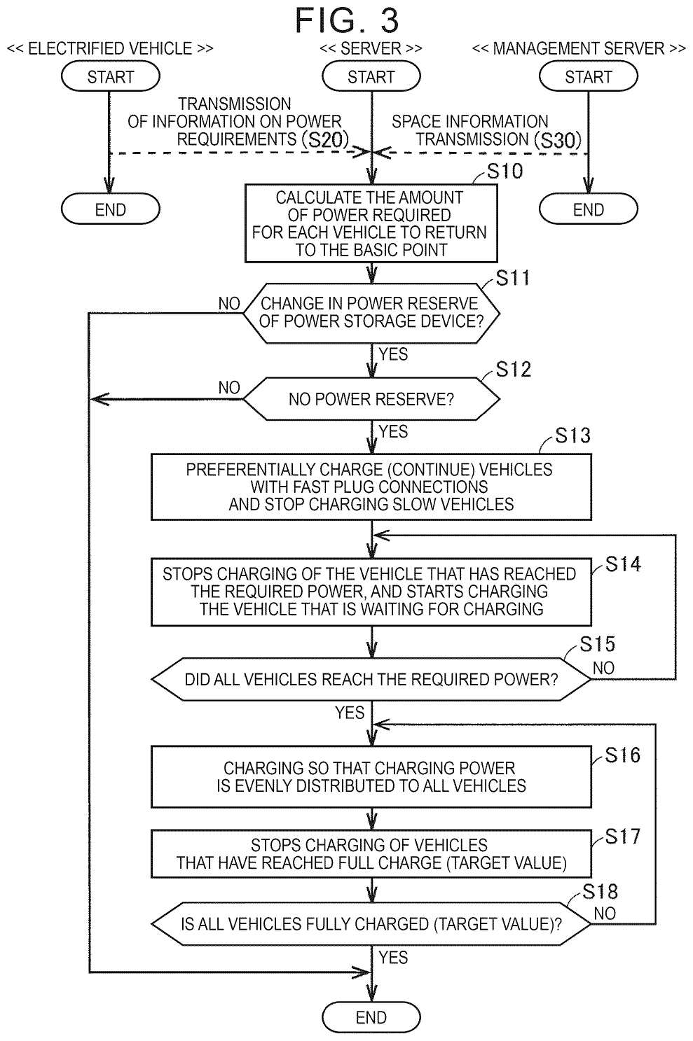

The processor 110 controls EVSE 220 charge of each of the plurality of electrified vehicle 10. Details will be described later with reference to FIG. 3.

The storage device 120 stores a program executed by the processor 110 and information (for example, a map, a mathematical expression, and various parameters) used in the program. In the storage device 120, information of a plurality of registered electrified vehicle 10, information of the registered users, information of the registered EVSE 220, and information of the registered management servers 210 are stored in a manner distinguished from each other by identification information (ID).

The communication device 130 includes various types of communication I/F. The communication device 130 is controlled by the processor 110. The communication device 130 is configured to be able to communicate with each of the management servers 210 and the plurality of electrified vehicle 10 (the communication unit 12).

The communication device 130 receives information about the required power from each of the plurality of electrified vehicle 10. The required amount of electric power means the amount of electric power required for each electrified vehicle 10 to move from EVSE 220 to the basic point 20 (in FIG. 1, the user's home of each electrified vehicle 10). The communication device 130 receives, from electrified vehicle 10, information on the required power when electrified vehicle 10 is connected to EVSE 220 or arrives at the accommodation facility 200. In the present embodiment, the required electric power is the size of State Of Charge (SOC) required to move from EVSE 220 to the basic point 20. Note that the necessary power amount according to the present embodiment is an example of the “first target value based on the necessary power amount” of the present disclosure.

The information on the required amount of electric power may include, for example, at least one of position information of the basic point 20, information on the electric power cost when moving from the basic point 20 to EVSE 220, information on the travel distance from the basic point 20 to EVSE 220, information on the catalogue of the electric power cost of electrified vehicle, and information on the amount of change in SOC when moving from the basic point 20 to EVSE 220. The processor 110 (a necessary power calculation unit 111 to be described later) calculates the necessary power amount of the respective electrified vehicle 10 based on the above-described necessary power amount. The processor 110 may acquire the required power calculated in electrified vehicle 10 through the communication device 130.

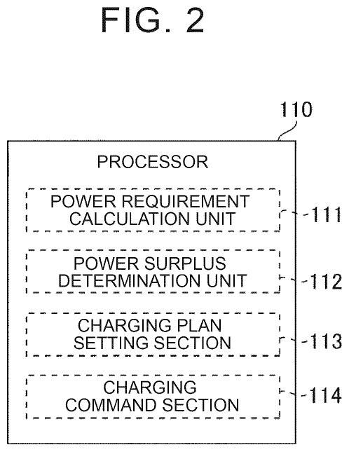

As illustrated in FIG. 2, the processor 110 includes a necessary power calculation unit 111, a power surplus determination unit 112, a charging plan setting unit 113, and a charging command unit 114. Each of the necessary power calculation unit 111, the power surplus determination unit 112, the charging plan setting unit 113, and the charging command unit 114 represents software in which functional features of the processor 110 are blocked. Each function will be described later.

The processor 110 (the necessary power calculation unit 111) calculates the necessary power amount of each of the plurality of electrified vehicle 10 based on the information on the necessary power amount received by the communication device 130. The information on the calculated required power quantity may be stored in the storage device 120 in association with the information (ID) of electrified vehicle 10.

The processor 110 (power surplus determination unit 112) determines whether or not there is a surplus in the power that can be used to charge electrified vehicle 10. Specifically, the processor 110 (the power surplus determination unit 112) performs the above-described estimation based on the electric power (kW) per unit time that can be extracted from the power storage device 201. For example, if kW is less than a reference of the charge power per unit time (kW) of electrified vehicle 10, it is determined that there is no power reserve. The above-mentioned kW may be calculated by the server 100. In addition, the determination may be performed without using the reference value. For example, if kW is less than the charge power of the newly plugged electrified vehicle 10, it may be determined that there is no power reserve.

The processor 110 (charge plan setting unit 113) sets a charge plan of each of the plurality of electrified vehicle 10. The processor 110 (charging plan setting unit 113) sets the charging plan based on the necessary power amount calculated by the necessary power calculation unit 111 and the determination result by the power surplus determination unit 112. Details will be described later.

The processor 110 (charging command unit 114) generates a command signal for instructing at least one of electrified vehicle 10 and EVSE 220 to charge. The command is transmitted to at least one of electrified vehicle 10 and EVSE 220 through the communication device 130. The charge between electrified vehicle 10 and EVSE 220 is controlled based on the command.

Here, when a plurality of electrified vehicles is sequentially charged, the charge amount of electrified vehicle to be charged later may be limited until the charge amount of electrified vehicle to be charged first reaches a predetermined value (for example, full charge). In this case, it is considered that electrified vehicle to be charged later becomes insufficiently charged and cannot be moved to its own basic point (charging basic point). In addition, it is considered that there is an electrified vehicle in electrified vehicle that desires to charge more than the electric power required to move to its own basic point.

Therefore, in the present embodiment, the server 100 executes the charging control (first charging control) so that the storage amount of each of the plurality of electrified vehicle 10 reaches the necessary power amount, and also executes the charging control (second charging control) to further charge each of the plurality of electrified vehicle 10 after the first charging control. Details will be described with reference to the sequence diagram of FIG. 3.

### Charging Control Sequence

Next, referring to FIG. 3, a charging control sequence by the server 100, the management server 210, and electrified vehicle 10 will be described.

In S20, each of the plurality of electrified vehicle 10 transmits to the server 100 (communication devices 130) the above-described power requirements.

In S30, the managing server 210 transmits, to the server 100 (the communication device 130), information on kW of electric power per unit time that can be extracted from the power storage device 201. Note that the information of the surplus power includes at least one of a value of the current surplus power and a predicted value of the surplus power after a predetermined time (for example, after 10 minutes). S30 process is periodically executed every predetermined time (for example, every minute).

In S10, the server 100 (necessary power calculation unit 111) calculates the necessary power amounts of the respective electrified vehicle 10 based on the data transmitted from the respective electrified vehicle 10 in S20. S10 process is executed every time electrified vehicle 10 transmits the required power quantity.

In S11, the server 100 (the power surplus determination unit 112) determines whether or not the electric power in the power storage device 201 has changed (or is predicted to change). Specifically, the server 100 executes S11 process on the basis of the information regarding the surplus power transmitted in S30. The case where the surplus power changes may be a case where the number of electrified vehicle 10 to be charged has changed (is predicted to change), a case where the power usage in the accommodation facility 200 has changed (is predicted to change), or the like. Note that the number of electrified vehicle 10 to be charged may be predicted based on the reserved state of charging, historical data on which charging has been performed in the past, and the like. Further, the prediction of the power usage amount in the accommodation facility 200 may be performed on the basis of historical information of the past power usage amount or the like. If it is determined that there is a change in the power reserve (Yes in S11), the process proceeds to S12. If it is determined that there is no change in the power reserve (No in S11), the process ends.

In S12, the server 100 (the power surplus determination unit 112) determines whether or not there is any surplus power in the power storage device 201. If there is no extra power (Yes in S12), the process proceeds to S13. If there is a surplus (No in S12), the process ends.

In S13, the server 100 (charging command unit 114) preferentially executes (continues) charging in an electrified vehicle 10 in which the order of plugging is earlier, and stops charging in an electrified vehicle 10 in which the order of plugging is later. For example, the contract power of the power storage device 201 is 10 kW. It is assumed that the charge power (max. power) is 3 kW, 2 kW, 2 kW, 2 kW, 3 kW in order from electrified vehicle 10 in which the plug-connected order is earlier. In this case, the first to fourth sets of the charge electric power having the sum of the charge electric powers equal to or less than 10 kW are charged, and the fifth and subsequent sets of the charge electric power are stopped (put into the charge waiting state).

In S14, the server 100 (the charging command unit 114) suspends charging in an electrified vehicle 10 where SOC has reached the required electric power. Further, the server 100 (the charging command unit 114) starts charging electrified vehicle 10 which is waiting for charging by the amount of the extra power increased due to the stoppage of the charging of electrified vehicle 10. Charging of electrified vehicle 10 waiting for charging is also started preferentially from an electrified vehicle 10 in which the plugged-in order is earlier.

In S15, the server 100 (the processor 110) determines whether or not the power storage amounts of all electrified vehicle 10 have reached the necessary power amount. When the amount of electric power stored in all electrified vehicle 10 has reached the required amount of electric power (Yes in S15), the process proceeds to S16. If there is an electrified vehicle 10 in which the amount of electric power stored has not reached the required amount of electric power (No in S15), the process returns to S14. Note that the charging control from S13 to S15 is an exemplary “first charging control” of the present disclosure.

In S16, the server 100 (charging command unit 114) executes charging control so that charge power is distributed evenly in all electrified vehicle 10. Specifically, when the contract power of the power storage device 201 is 10 kW and five electrified vehicle 10 are plugged in, the charge power of the respective electrified vehicle 10 is set to 2 kW. When there is an electrified vehicle 10 in which the upper limit value of the charging power is limited due to, for example, a relatively high SOC, the charging power of each of electrified vehicle 10 of the other plurality (N units) is set to (contract power-the upper limit value)/N (kW). When there is a plurality of electrified vehicles 10 in which the upper limit value of the charging power is limited, the charging power of each of the other plurality of electrified vehicle 10 is set to (total of the contract power-the upper limit value)/N (kW). Note that each of the plurality of electrified vehicle 10 to be charged in S16 is an exemplary “charging vehicle” of the present disclosure.

In S17, the server 100 (the charging command unit 114) suspends the charge in electrified vehicle 10 where the full charge has been reached. Charging in an electrified vehicle 10 in which a target value (for example, SOC=80%) of the charge amount is set in advance is stopped when the power storage amount reaches the target value. Note that the charging control of S16 and S17 is an exemplary “second charging control” of the present disclosure. Further, the full charge (target value) is an example of the “second target value” of the present disclosure.

In S18, the server 100 (processor 110) determines whether all electrified vehicle 10 have been charged until a full charge (target value) is reached. If all electrified vehicle 10 have been charged until the full charge (target value) is reached (Yes in S18), the process ends. If there is an electrified vehicle 10 that has not been charged until the full charge (target value) is reached (No in S18), the process returns to S16.

Charging by the server 100 (charging command unit 114) is executed based on the charging plan set by the charging plan setting unit 113.

As described above, in the present embodiment, the server 100 (the processor 110) executes the charging control (the first charging control) so that the storage amount of each of the plurality of electrified vehicle 10 reaches the necessary power amount, and after the first charging control, executes the charging control (the second charging control) for further charging each of the plurality of electrified vehicle 10. Thus, by the first charging control, it is possible to make the storage amount of each of the plurality of electrified vehicle 10 at least equal to or more than the necessary power amount. Consequently, it is possible to suppress electrified vehicle 10 from being unable to return to its own basic point due to insufficient charge. Further, since the second charging control is executed even after the first charging control, the electric storage amount of the respective electrified vehicle 10 can be made higher than the required electric power amount. Further, since the first charging control automatically charges up to at least the necessary power amount, it is possible to omit the time and effort for the user to set the setting value such as the charge amount in advance.

Further, in the present embodiment, the server 100 (the processor 110) performs control to equalize the charging power allocated to each of the plurality of electrified vehicle 10 after the charging is executed until the power storage amount of each of the plurality of electrified vehicle 10 reaches the necessary power amount. As a result, it is possible to suppress the occurrence of differences in the amount of electricity storage between electrified vehicle 10.

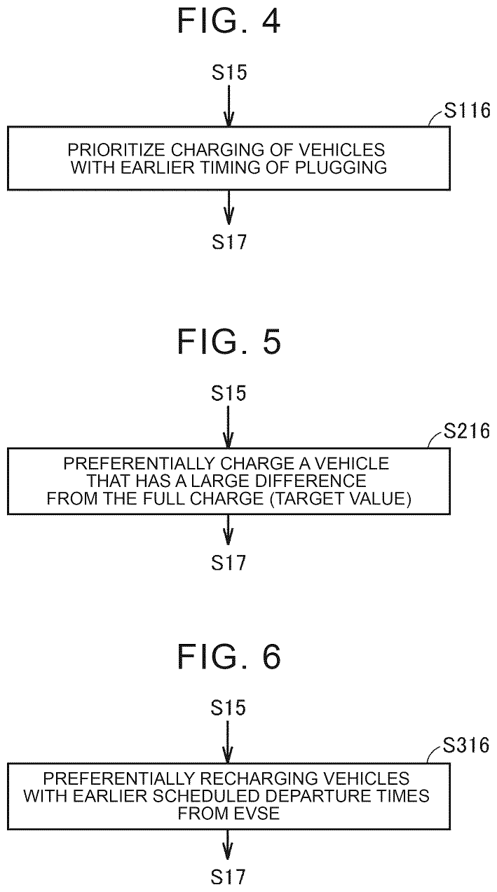

In the above-described embodiment, the charging power is distributed evenly in the charging after the storage amount of electrified vehicle 10 reaches the necessary power amount. A modification is shown in each of FIGS. 4 to 6.

In the modification illustrated in FIG. 4, S116 process is executed instead of the process of S16 (see FIG. 3) of the above-described embodiment. In S116, an electrified vehicle 10 that is plugged early is charged preferentially. For example, it is assumed that the contract power of the power storage device 201 is 10 kW, and the charge power (max. power) is 3 kWh, 2 kW, 2 kW, 2 kW, 3 kW in order from electrified vehicle 10 in which the order in which the power storage devices are plugged is earlier. In this case, the first to fourth sets of the charge electric power having the sum of the charge electric powers equal to or less than 10 kW are charged, and the fifth and subsequent sets of the charge electric power are stopped (put into the charge waiting state). The other steps are the same as those in the above embodiment.

In the modification illustrated in FIG. 5, S216 process is executed instead of the process of S16 (see FIG. 3) of the above-described embodiment. In S216, an electrified vehicle 10 having a large difference between the electric storage amount (required electric power amount) after S15 and the full charge (target value) is preferentially charged. For example, it is assumed that the contract power of the power storage device 201 is 10 kW and the charge power (maximum-output) is 3 kWh, 2 kW, 2 kW, 2 kW, 3 kW in order from electrified vehicle 10 where the difference is large. In this case, the first to fourth sets of the charge electric power having the sum of the charge electric powers equal to or less than 10 kW are charged, and the fifth and subsequent sets of the charge electric power are stopped (put into the charge waiting state). The other steps are the same as those in the above embodiment.

In the modification illustrated in FIG. 6, S316 process is executed instead of S16 of the above-described embodiment (see FIG. 3). In S316, an electrified vehicle 10 whose scheduled departure time from EVSE 220 is earlier is preferentially charged. For example, it is assumed that the contract power of the power storage device 201 is 10 kW, and the charge power (max. power) is 3 kWh, 2 kW, 2 kW, 2 kW, 3 kW in order from electrified vehicle 10 where the scheduled departure time is earlier. In this case, up to the first fourth table in which the sum of the charging power becomes equal to or less than 10 kW value is charged, and the charging of the fifth and subsequent tables is stopped (the state is put into the charging waiting state). The other steps are the same as those in the above embodiment.

In the above-described embodiment, as illustrated in FIG. 3, when it is determined in S12 that the power of the power storage device 201 has no surplus power, the processes after S13 are executed, but the present disclosure is not limited thereto. S12 (and S11) determination process may not be executed, and S13 and subsequent processes may be executed.

In the above-described embodiment, each of the plurality of electrified vehicle 10 is charged to a full charge (target value) after the storage amount of each of the plurality of electrified vehicle 10 reaches the necessary power amount. Only one of the plurality of electrified vehicle 10 may be charged to full charge (target value).

In the above-described embodiment and the modification illustrated in FIG. 4, an example in which an electrified vehicle 10 with a fast plug-connection is preferentially charged has been described, but the present disclosure is not limited thereto. For example, when electrified vehicle 10 performs contactless charging, the above-described priorities may be determined based on timings at which electrified vehicle 10 stops at the charging area. In addition, the above-described priorities may be determined based on timings at which electrified vehicle 10 arrives at the parking lot or the like of the accommodation facility 200.

In the above-described embodiment, the basic point 20 is an electrified vehicle 10 user's home, but the present disclosure is not limited to this. The basic point may be a facility where electrified vehicle 10 has been charged last time. In addition, the basic point may be a rechargeable facility closest to EVSE 220.

In the above-described embodiment, each of the plurality of electrified vehicle 10 is charged to the required electric power, but the present disclosure is not limited thereto. For example, each of the plurality of electrified vehicle 10 may be charged until a value obtained by adding a predetermined amount of electric power to the required amount of electric power (for example, a SOC+10% corresponding to the required amount of electric power) is reached. In this case, the above value obtained by adding a predetermined power amount to the necessary power amount is an example of the “first target value” of the present disclosure.

In the above embodiment, EVSE 220 (power storage device 201) is provided in the accommodation facility 200, but the present disclosure is not limited to this. EVSE 220 (power storage device 201) may be provided in a facility other than the accommodation facility 200 (for example, a theme park, a shopping mall, and the like).

In the above embodiment, the charge in electrified vehicle 10 where the storage amount reaches the necessary power amount at a relatively early stage is stopped until the storage amount of all electrified vehicle 10 reaches the necessary power amount. For example, the charge in electrified vehicle 10 where the storage amount reaches the necessary power amount at a relatively early stage may be resumed prior to the storage amount of all electrified vehicle 10 reaching the necessary power amount.

In the above-described embodiment, the above-described charging control is executed based on the power state (presence or absence of residual power) of the power storage device 201, but the present disclosure is not limited thereto. The above-described charging control may be executed based on the power status (presence or absence of residual power) of the power system that supplies power to EVSE 220.

In the above-described embodiment, the presence or absence of the power reserve is determined based on the relation between the electric power (contract electric power) that can be extracted per unit time from the power storage device 201 and the total amount of the charge electric power of the respective electrified vehicle 10. For example, the presence or absence of power surplus may be determined based on the amount of surplus power stored in the power storage device 201.

The embodiment disclosed herein should be considered as illustrative and not restrictive in all respects. The scope of the present disclosure is shown by the claims, rather than the above embodiments, and is intended to include all modifications within the meaning and the scope equivalent to those of the claims.

What is claimed is:

1. A control device for controlling charging of a plurality of electrified vehicles by a charger, the control device comprising:
an acquisition unit that acquires information regarding a necessary power amount that is required for moving from the charger to a basic point of each of the electrified vehicles; and
a processor that controls charging of each of the electrified vehicles by the charger, wherein
the processor executes first charging control such that a storage amount of each of the electrified vehicles reaches a first target value that is based on the necessary power amount, and
the processor executes, after the first charging control, second charging control to charge at least one of the electrified vehicles.

2. The control device according to claim 1, wherein, when the electrified vehicles include a plurality of charging vehicles to be charged in the second charging control, the processor performs control to equalize charging power allocated from the charger to each of the charging vehicles in the second charging control.

3. The control device according to claim 1, wherein:
the charger includes a charging connector that is connected to a charging port provided in each of the electrified vehicles; and
when the electrified vehicles include a plurality of charging vehicles to be charged in the second charging control, the processor preferentially charges, out of the charging vehicles, a charging vehicle of which timing of connecting the charging connector in the second charging control was early.

4. The control device according to claim 1, wherein:
each of the electrified vehicles is set to be charged by the second charging control until the storage amount reaches a second target value that is greater than the first target value; and
when the electrified vehicles include a plurality of charging vehicles to be charged in the second charging control, the processor preferentially charges, out of the charging vehicles, a charging vehicle regarding which a difference between the storage amount after the first charging control and the second target value in the second charging control is great.

5. The control device according to claim 1, wherein, when the electrified vehicles include a plurality of charging vehicles to be charged in the second charging control, the processor preferentially charges, out of the charging vehicles, a charging vehicle regarding which a scheduled departure time, for departing from the charger in the second charging control, is earlier.
